(19) United States
(12) Patent Application Publication
(10) Pub. No.: US 2011/0236197 A1
(43) Pub. Date: Sep. 29, 2011

(54) Flow guide structure for an exhaust gas turbine

(76) Inventors: Hermann Burmeister, Heidelberg (DE); Akihiro Ohkita, Frankfurt (DE); Yukio Takahashi, Tokyo (JP)

(21) Appl. No.: 11/295,138

(22) Filed: Dec. 6, 2005

Related U.S. Application Data
(63) Continuation-in-part of application No. PCT/EP2004/004758, filed on May 5, 2004.

(30) Foreign Application Priority Data
Jun. 7, 2003 (DE) 103 25 985.6

(51) Int. Cl. F03B 3/16

(52) U.S. Cl. 415/204

(57) ABSTRACT

In a flow guide structure for an exhaust gas turbine of a turbocharger including a support ring and a contoured casing which are disposed at a distance from one another by means of spacer elements and between which adjustable guide vanes are rotatably supported, the contoured casing being disposed in a spiral housing so as to be axially displaceable therein and delimiting a lateral outer contour of a rotor with clearance, while the support ring is centered and mounted relative to a support housing of the exhaust gas turbine by means of an annular flexible support element, the support element comprises a component with a uniform wall thickness.

This is a Continuation-In-Part Application of International Application PCT/EP2004/004758 filed May 5, 2004 and claiming the priority of German application 103 25 985.6 filed Jun. 7, 2003.

### BACKGROUND OF THE INVENTION

The invention relates to a flow guide structure for an exhaust gas turbine of a turbocharger including a contoured casing and a support ring arranged in spaced relationship by spacer elements with flow guide vanes disposed in the space between the turbine and the support ring.

A turbocharger having an exhaust gas turbine and a compressor is known from U.S. Pat. No. 2,860,827 A, the rotor with the rotor blades of the exhaust gas turbine driving the rotor of a compressor by means of a driveshaft. The driveshaft is mounted in a bearing housing which is part of a turbine housing. The rotor blades are delimited laterally with play by a contoured casing, an axially directed end of which is inserted, in a sealing manner by means of a sealing ring, into an outlet cross-section of a spiral housing. Guide vanes which adjoin the rotor blades at their radially outer side are provided between the part of the contoured casing which extends radially outward and a bearing ring, which guide vanes are rotatably mounted in the bearing ring and can be adjusted by means of an adjusting mechanism mounted in the bearing housing. The contoured casing and bearing ring are screwed to one another by means of screws and are held at a distance from one another by means of spacer ribs.

A flexible assembly ring holds and centers the bearing ring in the housing. For this purpose, the assembly ring has a z-shaped cross-sectional profile, a radially outwardly directed outer flange engaging in the slit between the bearing housing and the spiral housing and simultaneously being held with the housing screws, while an inner radially directed flange overlaps the bearing ring at the outer circumference and is screwed to the bearing ring. The assembly ring has a relatively thin cylindrical section between the inner and outer flange, by means of which section the contoured casing is flexibly held with the distributor so that the contoured casing, together with the radial seal at the outlet of the exhaust gas turbine, can undergo thermal expansion without distorting the adjusting device of the guide vanes. The type of mounting of the adjusting device is complex in terms of manufacture and assembly. The assembly ring also has varying wall thicknesses and its manufacture is therefore expensive.

A guide vane for a control device for a turbocharger is known from EP 1 227 221 in which a guide vane carrier plate, guide vanes, levers and an adjusting ring can be manufactured, transported and installed as a module, the individual parts being captively connected to the guide vane carrier plate after the connection of guide vane shafts and guide vane levers.

It is the object of the present invention to provide a control ring for adjustable guide vanes of a gas turbine of a turbocharger in a simple and cost-effective manner.

### SUMMARY OF THE INVENTION

In a flow guide structure for an exhaust gas turbine of a turbocharger including a support ring and a contoured casing which are disposed at a distance from one another by means of spacer elements and between which adjustable guide vanes are rotatably supported, the contoured casing being disposed in a spiral housing so as to be axially displaceable therein and delimiting a lateral outer contour of a rotor with clearance, while the support ring is centered and mounted relative to a support housing of the exhaust gas turbine by means of an annular flexible support element, the support element comprises a component with a uniform wall thickness.

The bearing ring is expediently captively connected to the spacer element, to the contoured casing and to the support element by means of a rivet connection, and preferably forms an assembly unit with the guide vanes which are adjustably mounted between the bearing ring and the contoured casing. This assembly unit is held and centered in the housing of the exhaust gas turbine by virtue of the fact that an outer radially extending flange of the support element is clamped between the support housing and a spiral housing of the exhaust gas turbine.

In a particular embodiment of the invention, the spacer elements are sealed bolts having rivet heads at one end. By means of the rivet heads, the spacer bolts are connected both to the contoured casing and to the support ring. It is however also possible to captively connect the support ring, the contoured casing, and the support element to one another independently of the spacer element by means of a rivet connection, a screw connection, a welded connection or an interference fit, such that they form an assembly unit. The spacer element may in this case be of any desired design and be formed for example by means of a spacer rib on the contoured casing and/or on the support ring.

The support element is expediently connected to the support ring on the side facing away from the exhaust gas, so that the inner flange is not directly exposed to the hot exhaust gases and the support element can be manufactured from a cost-effective material. A metal holding plate can be attached to the bearing ring with the same fastening means as used for the support element, which holding plate forms, with integrally formed angle supports, a receiving space toward the support element for a control ring for the guide vanes. Both the holding plate and the control ring and also other parts of a control mechanism for the guide vanes can be included in the assembly unit by virtue of the fact that they are captively connected to the support ring. This results in both a simplification of assembly and in simple, short components with very low thermal expansions. It can nonetheless be expedient to provide an equalization ring between the holding ring and the support element or support ring for the purpose of axial calibration of the installation space of the control ring. The equalization ring is arranged between the holding plate and the support element and is preferably fastened to the support ring using the same fastening means as for the support element.

In order to minimize the thermal stresses in the mounting of the support element, it may also be expedient to connect the support element to the support ring on the side facing the exhaust gas flow.

The invention will become more readily apparent from the following description of exemplary embodiments of the invention as illustrated in the accompanying drawings.

### BRIEF DESCRIPTION OF THE DRAWINGS

FIG. 1 is a cross-sectional view of an exhaust gas turbine,

FIG. 2 shows in a partial longitudinal section a flow guide structure without the guide vanes and

FIG. 3 shows in a partial longitudinal section a section of a control ring for the guide vanes.

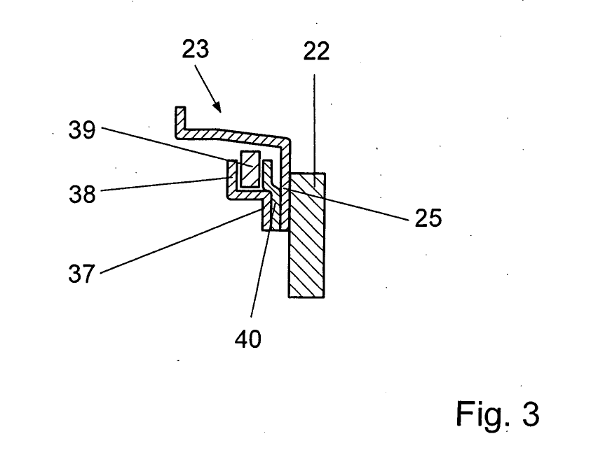

### DESCRIPTION OF A PARTICULAR EMBODIMENT

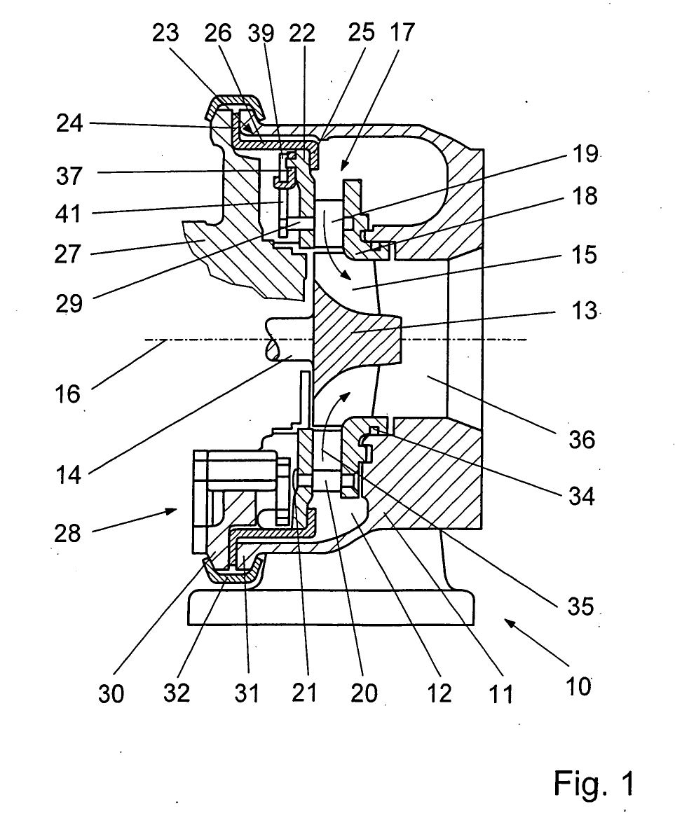

As shown in FIG. 1, an exhaust gas turbine 10 of an exhaust gas turbocharger includes a support housing 27 in which a shaft 14 of a rotor 13 is mounted so as to be rotatable about a rotational axis 16. The rotor 13 of the exhaust gas turbine 10 drives the rotor (not illustrated) of a compressor of the turbocharger by means of the shaft 14. The rotor 13 has rotor blades 15 onto which exhaust gas is directed via a radially outwardly lying flow guide structure 17 in the direction of flow as indicated by arrows 35. The exhaust gas is guided into an exhaust gas system (not shown) of an internal combustion engine via a turbine outlet 36.

The flow guide structure 17 substantially comprises a contoured casing 18 which forms a lateral delimitation of the rotor blades 15 with some clearance and is held at a distance from a support ring 22 by means of spacer elements 20 in the form of spacer bolts. The spacer bolts 20 have rivet heads 21 at their ends, by means of which the contoured casing 18 and the support ring 22 are firmly engaged with shoulder stops of the spacer elements 20. Adjustable guide vanes 19 are rotatably mounted between the radially outwardly directed part of the contoured casing 18 and the support ring 22. The guide vanes 19 are adjustable as a function of engine operating parameters by an adjusting mechanism 28 by means of a control ring 39, operating levers 41 and operating shafts 29 connected to the guide vanes 19. The support ring 22 and the components, in particular the contoured casing 18, the guide vanes 19, the spacer elements 20, the support ring 22 and parts of the control mechanism 28 captively connected thereto to form an assembly unit, are held and centered in the housing 11, 27 of the exhaust gas turbine 10 by means of an annular flexible support element 23. The support element 23 has a substantially z-shaped cross section with an outer radial flange 24 and an inner radial flange 25. A cylindrical part 26, which significantly contributes to the flexibility of the supporting element 23 on account of its dimensioning, extends between the two flanges 24, 25. The supporting element 23 has a uniform wall thickness and is expediently produced from sheet metal. While the inner flange 25 is fastened to the support ring 22, the outer flange 24 is clamped between a fastening flange 30 of the support housing 27 and a fastening flange 31 of a spiral housing 11, by virtue of the fact that the two fastening flanges 30, 31 are held together by means of a clamping ring 32 which is of V-shaped cross section.

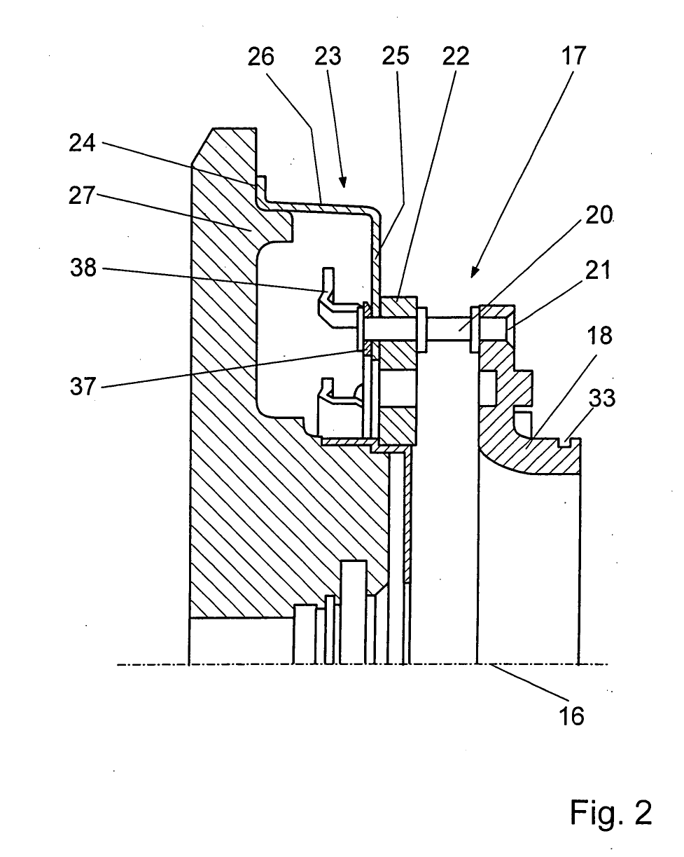

The spiral housing 11 has a spiral duct 12, the flow cross-section of which narrows around the circumference of the spiral housing 11 in a known way from a tangential inlet (not shown). The axially extending part of the contoured casing 18 is inserted in a restrictedly axially displaceable manner into the spiral housing 11 and is sealed off at its outer circumference by means of a radial sealing ring 34 which is embedded in a groove 33 (FIG. 2). The flow guide structure 17 can thus be set to different thermal expansions during operation of the exhaust gas turbine 10 without distortion of neighboring components, in particular of the adjusting mechanism 28.

While the support element 23 in the embodiment of FIG. 1 engages the support ring 22 with its inner flange 25 and its inner flange 25 is fastened to the bearing ring 22, the support element 23 in FIG. 2 has an inner flange 25 which is fastened to the support ring 22 on the side facing away from the exhaust gas flow and is thus protected from the hot exhaust gases. The spacer element 20 in the form of a spacer bolt, which has rivet heads 21 on the end, can simultaneously serve to fasten the support element 23. Furthermore, a metal retaining plate 37 can be fastened to the support ring 22 by means of the spacer element 20. The retaining plate 37 forms, with its integrally formed angle supports 38, an installation space toward the support element 23 for the support ring 39.

In order to control the axial clearance necessary for the control ring 39 under the varyingly hot operating conditions of the exhaust gas turbine 10, an equalization ring 40 is provided between the support ring 37 and the support element 23. Since the equalization ring behaves similarly to the support ring 37 under operating conditions, its distance from the support ring 37 or its angle supports 38 remains constant, with the result that the set clearance is maintained during operation and thermal expansions and deformations do not adversely affect the operation of the control mechanism.

What is claimed is:

1. A flow guide structure for an exhaust gas turbine of a turbocharger, comprising a support housing (27), a rotor (13) rotatably supported in the support housing (27) a spiral housing (11) mounted to the support housing (27) and a contoured casing (18) axially movably supported by the spiral housing so as to extend around the rotor (13) and delimiting a flow path through the rotor with a predetermined clearance, the flow guide structure including a support ring (22) supported by a spacer element (20) in spaced relationship from the contoured casing (18) so as to form therebetween a flow path from the spiral housing (11) to the rotor (13), flow guide vanes (19) pivotally supported on the support ring (23) in the flow path for controlling the flow of exhaust gases from the spiral housing (11) to the rotor (13), the support ring being mounted to the support housing (27) by an annular flexible support element (26) which consists of a component of uniform wall thickness.

2. The flow guide structure as claimed in claim 1, wherein the support ring (22) is captively connected to the spacer element (20), to the contoured casing (18) and to the support element (23) by means of a rivet connection so as to form an assembly unit.

3. The flow guide structure as claimed in claim 2, wherein the spacer element (20) is a spacer bolt with a rivet head (21) formed integrally at least at one end of the spacer bolt (20).

4. The flow guide structure as claimed in claim 1, wherein the support ring (22) is captively connected independently of the spacer element (20) to the contoured casing (18) and the support element (23) by means of one of a rivet connection, a screw connection, a welded connection and an interference fit and thus forms an assembly unit.

5. The flow guide structure as claimed in claim 1, wherein the support element (23) is connected to the support ring (22) on the side facing away from the exhaust gas flow.

6. The flow guide structure as claimed in claim 5, wherein an annular metal retaining plate (37) is fastened to the support ring (22) on the side facing away from the exhaust gas flow, which retaining plate forms, with integrally formed angled supports (38), a receiving space toward the support element (23) for a control ring (39) for the guide vanes (19).

7. The flow guide structure as claimed in claim 6, wherein an equalization ring (40) is provided between the retaining plate (37) and the support element (23).

8. The flow guide structure as claimed in claim 6, wherein some of the components (18, 20, 22, 23) of the flow guide structure including an adjusting device (28, 29, 37, 39, 40) are pre-assembled and are captively held together so as to form a partial assembly of flow guide structure.

9. The flow guide structure as claimed in claim 1, wherein the support element (23) is fastened to the support ring (22) on the side facing the exhaust gas flow.
